(19) United States
(12) Patent Application Publication
(10) Pub. No.: US 2025/0013982 A1
(43) Pub. Date: Jan. 9, 2025

(54) LOGISTICS WAREHOUSE CONTROL SYSTEM AND LOGISTICS WAREHOUSE CONTROL METHOD

(71) Applicant: HITACHI, LTD., Tokyo (JP)

(72) Inventors: Takumi KATO, Tokyo (JP); Ryota KAMOSHIDA, Tokyo (JP)

(21) Appl. No.: 18/710,759

(22) PCT Filed: Nov. 16, 2022
(86) PCT No.: PCT/JP2022/042488

§ 371 Date: May 16, 2024

(30) Foreign Application Priority Data
Dec. 9, 2021 (JP) 2021-200325

(51) Int. Cl. G06Q 10/087; B65G 1/137

(52) U.S. Cl. CPC G06Q 10/087; B65G 1/1373

(57) ABSTRACT

A disclosed logistics warehouse control system includes: an order management unit configured to manage a plurality of orders given to a logistics system; and a parameter determination unit configured to determine, for a plurality of subsystems each in charge of a plurality of logistics operation processes in the logistics system, a parameter related to an operation of each subsystem based on the plurality of orders, in which the parameter determination unit inputs the determined parameter to the subsystem, and causes the plurality of orders to be processed in a state where the parameter is applied.

### TECHNICAL FIELD

The present invention relates to a logistics warehouse control system and a logistics warehouse control method to control a logistics system.

### BACKGROUND ART

In the related art, in order to improve efficiency of a logistics system, there is a technique disclosed in JP2007-39181A (PTL 1). This publication discloses “a picking schedule creation system for creating a schedule for picking an ordered article by a method selected from a plurality of picking methods, in which a picking method of a shipping operation management table in which picking information related to the picking method is stored in a rewritable manner for each shipping destination of the ordered article is selected and input from the plurality of picking methods (order picking and total picking), and a picking schedule is created according to the picking information input to the shipping operation management table”.

### CITATION LIST

### Patent Literature

PTL 1: JP2007-39181A

### SUMMARY OF INVENTION

### Technical Problem

The related art is insufficient in that “parameters related to an operation of a subsystem are determined so as to improve performance of the logistics system for the purpose of efficiently performing an operation from a viewpoint of overall optimization”. For example, a setting value of the parameter of the subsystem to be set changes according to a tendency of an order representing an order from a customer and characteristics or a combination of subsystem groups constituting the logistics system. However, until now, the setting value of the parameter of the subsystems is set and developed for the purpose of improving productivity of one subsystem, so that the setting value cannot be determined in consideration of characteristics of the entire logistics system.

As a specific example, in PTL 1, it is possible to change a parameter indicating a picking method for each shipping destination, but it is not possible to appropriately perform a determination by combining parameters other than those of a picking system.

Therefore, the invention provides a control method of improving performance of an entire logistics system by determining parameters of not only a picking system but also other subsystems so that performance of an entire system is improved, for example, by considering characteristics and compatibility of each system, when a logistics warehouse control system determines parameters of a subsystem group.

### Solution to Problem

In order to achieve the above object, one representative logistics warehouse control system according to the invention includes: an order management unit configured to manage a plurality of orders given to a logistics system; and a parameter determination unit configured to determine, for a plurality of subsystems each in charge of a plurality of logistics operation processes in the logistics system, a parameter related to an operation of each subsystem based on the plurality of orders, in which the parameter determination unit inputs the determined parameter to the subsystem, and causes the plurality of orders to be processed in a state where the parameter is applied.

One representative logistics warehouse control method according to invention includes: an order management step of managing a plurality of orders given to a logistics system; a parameter determination step of determining, for a plurality of subsystems each in charge of a plurality of logistics operation processes in the logistics system, a parameter related to an operation of each subsystem based on the plurality of orders; and a step of inputting the determined parameter to the subsystem, and processing the plurality of orders in a state where the parameter is applied.

### Advantageous Effects of Invention

When parameters of a subsystem group are determined, it is possible to improve performance of the entire logistics system by determining a suitable combination of parameters of not only a single subsystem but also a plurality of subsystems.

### BRIEF DESCRIPTION OF DRAWINGS

FIG. 1 is a schematic diagram of a logistics warehouse control system according to an embodiment of the invention.

FIG. 2 is a schematic diagram of a configuration and parameters of a subsystem in the logistics warehouse control system according to the embodiment of the invention.

FIG. 3 is a schematic diagram showing steps of a parameter determination and an input to a subsystem group in the logistics warehouse control system according to the embodiment of the invention.

FIG. 4 is a schematic diagram of orders representing orders in the logistics warehouse control system according to the embodiment of the invention.

### DESCRIPTION OF EMBODIMENTS

Hereinafter, an embodiment will be described with reference to the drawings.

### Embodiment 1

In a logistics warehouse control system according to the invention, it is possible to control a logistics warehouse including a plurality of subsystems in a manner that improves productivity of the entire logistics warehouse rather than productivity of a single subsystem. Hereinafter, an embodiment of the invention will be described with reference to the drawings.

### (1) First Embodiment

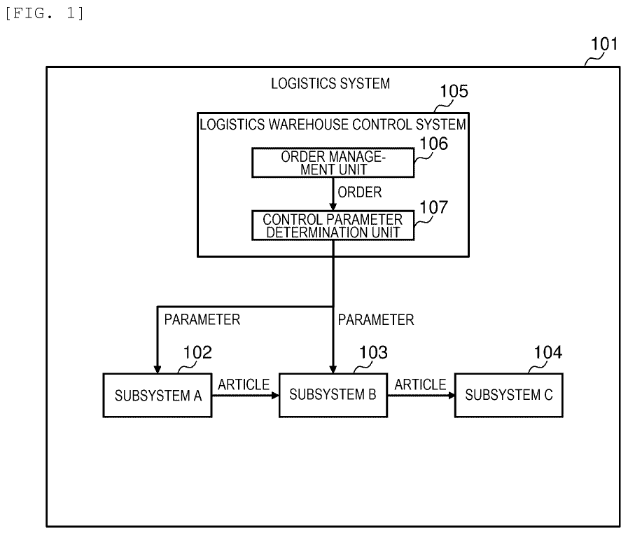

Hereinafter, a first embodiment of a logistics warehouse control system according to the invention will be described based on the drawings. An outline of a configuration of the logistics warehouse control system will be described with reference to FIG. 1. As shown in FIG. 1, the logistics warehouse control system includes a logistics system 101, a logistics warehouse control system 105, a subsystem A102, a subsystem B103, and a subsystem C104. The logistics warehouse control system 105 includes an order management unit 106 and a control parameter determination unit 107.

The subsystem A102, the subsystem B103, and the subsystem C104 are a group of areas and operation subjects for performing a logistics operation corresponding to a certain process of a logistics system. The operation subject is, for example, a material handling device. The subsystem A102, the subsystem B103, and the subsystem C104 have a capability of passing articles to each other. In the outline of the configuration shown in FIG. 1, articles are delivered from the subsystem A102 to the subsystem B103, from the subsystem B103 to the subsystem A102, and from the subsystem B103 to the subsystem C104. The control parameter determination unit 107 receives at least two orders representing customer orders from the order management unit 106 as an input. The control parameter determination unit 107 determines control parameters of the subsystem A102 and the subsystem B103, and provides the control parameters as inputs to at least two subsystems. In the outline of the configuration shown in FIG. 1, the determined parameters are given as inputs to the subsystem A102 and the subsystem B103.

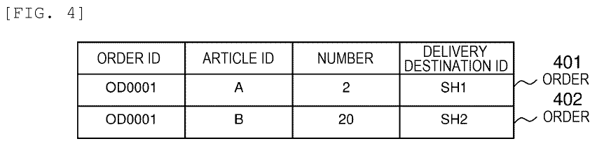

The order will be described with reference to FIG. 4. The order includes information on at least an article and a delivery destination related to shipping, storage in a warehouse, and delivery from the warehouse for various articles. For example, an order 401 and an order 402 are a set of an order ID, an article ID and the number of articles, and a delivery destination ID. The order ID is a character string, a number, or the like that is an identifier of a unique order in a logistics system. The article ID is a name, a number, or the like indicating a type of the article. The delivery destination ID is a customer name in a shipping destination or an ID of a shipping destination, a store name, a name or a number of a collection station to be delivered, or the like.

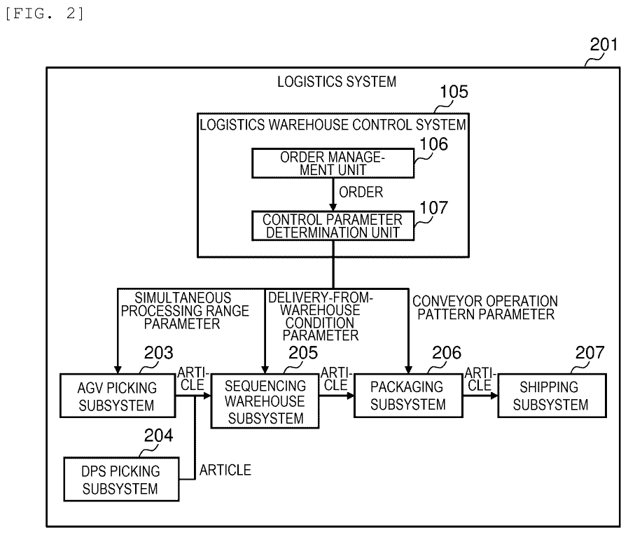

A specific example of the configuration of the logistics warehouse control system shown in FIG. 1 will be described with reference to FIG. 2. As shown in FIG. 2, the logistics warehouse control system includes a logistics system 201, a logistics warehouse control system 105, an automated guided vehicle (AGV) picking subsystem 203, a digital picking system (DPS) picking subsystem 204, a sequencing warehouse subsystem 205, a packaging subsystem 206, and a shipping subsystem 207. The logistics warehouse control system 105 includes the order management unit 106 and the control parameter determination unit 107.

An article is delivered from the AGV picking subsystem 203 and the DPS picking subsystem 204 to the sequencing warehouse subsystem 205, from the sequencing warehouse subsystem 205 to the packaging subsystem 206, and from the packaging subsystem 206 to the shipping subsystem 207. The AGV picking subsystem 203 is a picking system, and is a system in which an AGV transports a shelf storing articles to an operation subject (a robot or the like) performing picking, and the operation subject (the robot or the like) picks up and sorts the articles from the transported shelf.

The AGV picking subsystem 203 has a characteristic of being able to store many types of articles. The DPS picking subsystem 204 is a picking system, and is a system in which an operation subject (a robot or the like) picks up and sorts articles from a storage shelf that stores articles that have a function of displaying information related to picking on a frontage.

The DPS picking subsystem 204 can hold smaller number of articles than the AGV picking subsystem 203, but the DPS picking subsystem 204 has a characteristic of being able to perform a picking operation faster than the AGV picking subsystem 203, and is suitable for a picking operation for articles that are frequently delivered from a warehouse.

In the present embodiment, the AGV picking subsystem 203 and the DPS picking subsystem 204 have different types of articles. Articles that are sorted by the AGV picking subsystem 203 and the DPS picking subsystem 204 are delivered to and stored in the sequencing warehouse subsystem 205. When articles that belong to a predetermined group to which a plurality of orders belong among the stored articles are collected, for example, when articles to be put into one shipping box are collected, the sequencing warehouse subsystem 205 delivers the articles to the packaging subsystem 206 for a later operation. The packaging subsystem 206 packages articles in a shippable state, and delivers the packaged articles to the shipping subsystem 207 for a later operation. There are a plurality of operation stations in the packaging subsystem 206. A conveyor in the packaging subsystem 206 determines an amount of boxes that flow to each station. The operation stations include an operation station in which a versatile operation subject having high versatility is in charge of an operation and an operation station in which a specialized operation subject including a picking robot and a box sealing machine is in charge of an operation. Boxes that can be sent to an operation station having a specialized operation subject are limited. Depending on articles in a box, it is necessary to send the articles to an operation station having a versatile operation subject. The operation station having the versatile operation subject can handle all articles. That is, after a large number of boxes are sent to the operation station having the versatile operation subject, when a box that can be handled only by the versatile operation subject flows, the operation station having the versatile operation subject merely waits for the box on a conveyor. On the other hand, when the versatile operation subject does not perform an operation for a long time, performance of the packaging subsystem 206 decreases. It is important to appropriately send a box to the operation station having the versatile operation subject, so that the box does not wait on the conveyor and the versatile operation subject is not left waiting. The shipping subsystem 207 temporarily holds an article in a shippable state, in a buffer corresponding to a shipping destination, and ships the article in a shippable state, for example, when a shipping truck arrives.

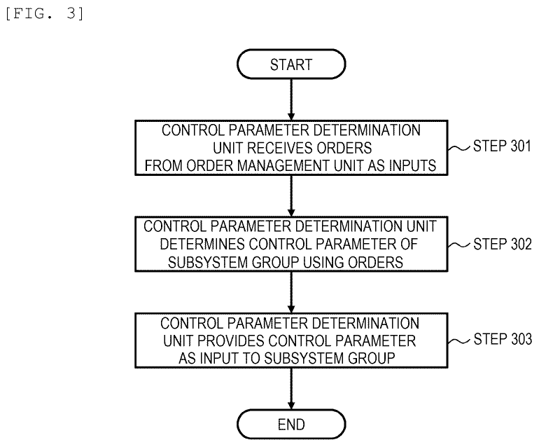

An operation flow of the logistics warehouse control system will be described with reference to FIG. 3. First, the control parameter determination unit 107 receives at least two or more orders as inputs from the order management unit 106 (step 301). Next, the control parameter determination unit 107 determines a control parameter of a subsystem group using the received orders (step 302). In the example shown in FIG. 2, an order simultaneous processing range parameter of the AGV picking subsystem 203, a delivery-from-warehouse condition parameter of the sequencing warehouse subsystem 205, and a conveyor operation pattern parameter of the packaging subsystem 206 correspond to the determined parameter. Next, the control parameter determination unit 107 provides the determined parameter as an input to the subsystem group (step 303). In the example shown in FIG. 2, the AGV picking subsystem 203, the sequencing warehouse subsystem 205, and the packaging subsystem 206 are the subsystem group.

In order to increase productivity of the AGV picking subsystem, it is important to simultaneously pick up orders that have the same article ID to reduce the number of times of shelves are transported. It is effective to collectively pick up products with the same article ID, since not only an order with the closest separation time but also orders to be shipped at a plurality of times ahead of separation times. The simultaneous processing range parameter is a value indicating how many orders of articles to be shipped ahead of a separation time are to be processed simultaneously.

In order to increase productivity of a sequencing process, it is important to reduce a time for which articles stay in a sequencing warehouse by not only picking up more articles per unit time based on a productivity index of a normal picking system, but also synchronously processing orders for the same shipping destination in two picking systems, that is, the AGV picking subsystem 203 and the DPS picking subsystem 204.

It is important for a sequencing warehouse to reduce waiting for the packaging subsystem and thereafter by shipping articles that are assembled to a certain extent all at once. Therefore, it is important to set appropriate conditions for starting shipping, that is, what percentage of articles for a certain shipping destination are to be collected before shipping begins. The delivery-from-warehouse condition parameter is a value indicating what percentage of articles for a certain shipping destination are collected in the sequencing warehouse before shipping begins.

As described above, when the orders to be shipped at a plurality of times ahead of separation times are collectively processed, there may be a delay in preparation of articles for a certain shipping destination at the sequencing warehouse, resulting in a buildup of articles that cannot be shipped from the sequencing warehouse. However, by appropriately setting a condition for delivery from the sequencing warehouse, it is possible to reduce a time to wait for a process after the sequencing warehouse. That is, it is possible to improve the productivity of the AGV picking subsystem 203 by appropriately setting the simultaneous processing range parameter, and it is possible to improve productivity of the logistics system by appropriately setting the delivery-from-warehouse condition parameter to start shipping from the sequencing warehouse subsystem 205 early to the extent that the shipping is not affected by the delay of the preparation of the articles.

The packaging subsystem 206 can have a control pattern in which a conveyor preferentially sends a box delivered from the sequencing warehouse subsystem 205 to the operation station having the versatile operation subject, a control pattern in which a conveyor preferentially sends a box to an automated station, and a control pattern in which a station is randomly selected. The conveyor operation pattern parameter is a value indicating which control pattern is to be used.

Therefore, by using the invention, it is possible to set together a parameter (an integer value takes a value between 1 and a maximum number of separation times that can be processed simultaneously) indicating how many orders ahead of separation times are processed at the same time and a parameter (0 to 100%) indicating what percentage of shipping boxes to be shipped at the earliest separation time are collected to start shipping from the sequencing warehouse, and performance of a logistics warehouse is improved.

In one embodiment, the control parameter determination unit 107 calculates productivity of the logistics system 201 when a certain combination of the simultaneous processing range parameter and the delivery-from-warehouse condition parameter is input using a simulator of the logistics system 201 based on the order given as an input, and selects a combination of parameters that is expected to result in the highest productivity as a control parameter to be set. Since the number of combination patterns of control parameters increases in an exponential manner with respect to the number of control parameters and calculation cost is too high, it is not possible to evaluate all combinations using a simulator. Therefore, as an example of a method of effectively searching for a combination to be evaluated, there is a method of calculating a combination of parameters with which the productivity of the entire logistics system is increased by designating some of the parameters as a combination expected to be useful, considering a past record of the logistics system and a general property that productivity of a downstream process is not improved unless productivity of an upstream process is improved, and randomly changing the undesignated parameters and evaluating undesignated parameters by a simulator.

As described above, the disclosed logistics warehouse control system includes: an order management unit configured to manage a plurality of orders given to a logistics system; and a parameter determination unit configured to determine, for a plurality of subsystems each in charge of a plurality of logistics operation processes in the logistics system, a parameter related to an operation of each subsystem based on the plurality of orders, in which the parameter determination unit inputs the determined parameter to the subsystem, and causes the plurality of orders to be processed in a state where the parameter is applied.

Thus, in the logistics system in which the logistics warehouse control system includes a plurality of subsystems, the productivity of the logistics system is improved by determining a combination of parameters of two or more subsystems.

Specifically, when determining the parameters of the subsystem group, the logistics warehouse control system determines a suitable combination of the parameters of the plurality of subsystems based on an order indicating an order from a given customer, and provides the combination as an input to the subsystem. Accordingly, it is possible not only to improve productivity of a single subsystem but also to improve the productivity of the entire logistics system.

According to the disclosed system, the parameter determination unit evaluates productivity of the entire logistics system for a combination of parameters of the plurality of subsystems, and determines a parameter to be applied to each of the plurality of subsystems.

At this time, the parameter determination unit may determine the parameter by giving priority to an upstream subsystem in the logistics system, or may reduce a search range of a combination of the parameters by giving priority to a parameter having a record of use.

With this operation, the productivity of the entire logistics system can be improved by simple processing.

According to the disclosed system, the plurality of subsystems include at least one of a picking system, a sequencing warehouse, and a conveyor.

By including a picking system in at least one of the subsystems, it is possible to adjust a picking operation, which is a beginning of a shipping process in a logistics warehouse in accordance with other systems, and the productivity of the logistics system is improved.

Since at least one of the subsystems is a sequencing warehouse, it is possible to appropriately adjust an influence on a process after the sequencing warehouse, and the productivity of the logistics system is improved.

Since at least one of the subsystems includes a conveyor, allocation of an operation in the subsystem can be appropriately adjusted, and the productivity of the logistics system is improved.

The parameter includes a threshold value that is a trigger of material handling in the subsystem. Accordingly, the productivity of the logistics system is improved by appropriately setting an operation of the sequencing warehouse subsystem 205.

The parameter includes identification information that specifies a control pattern of the subsystem. Accordingly, an operation of the subsystem can be appropriately adjusted, and the productivity of the logistics system is improved.

Since the parameter determination unit has a function of outputting performance of the logistics system according to the parameter, the parameter can be determined after an operator confirms the performance.

The parameter determination unit can determine a combination of the parameters by searching a parameter space based on simulation. By calculating the productivity of the logistics system using the simulator, it is possible to prepare information necessary for appropriately determining the control parameter. This may be, for example, an approximation or a neural network having a function of calculating the productivity of a logistics system, instead of a simulator.

Although the invention made by the present inventors has been specifically described based on the embodiment of the invention, the invention is not limited to the embodiment of the invention, and it is needless to say that various modifications can be made without departing from the gist of the invention.

For example, in the embodiment, a logistics system based on picking is shown, but the invention can also be applied to a system based on a sequencing warehouse.

A part of the operation subject may be a worker.

### REFERENCE SIGNS LIST

101: logistics system
102 to 104: subsystem
105: logistics warehouse control system
106: order management unit
107: control parameter determination unit
203: AGV picking subsystem
204: DPS picking subsystem
205: sequencing warehouse subsystem
206: packaging subsystem
207: shipping subsystem

1. A logistics warehouse control system comprising:
an order management unit configured to manage a plurality of orders given to a logistics system; and
a parameter determination unit configured to determine, for a plurality of subsystems each in charge of a plurality of logistics operation processes in the logistics system, a parameter related to an operation of each subsystem based on the plurality of orders, wherein
the parameter determination unit inputs the determined parameter to the subsystem, and causes the plurality of orders to be processed in a state where the parameter is applied.

2. The logistics warehouse control system according to claim 1, wherein
the parameter determination unit evaluates productivity of the entire logistics system for a combination of parameters of the plurality of subsystems, and determines a parameter to be applied to each of the plurality of subsystems.

3. The logistics warehouse control system according to claim 2, wherein
the parameter determination unit determines the parameter by giving priority to an upstream subsystem in the logistics system.

4. The logistics warehouse control system according to claim 2, wherein
the parameter determination unit reduces a search range of a combination of the parameters by giving priority to a parameter having a record of use.

5. The logistics warehouse control system according to claim 1, wherein
the plurality of subsystems include at least one of a picking system, a sequencing warehouse, and a conveyor.

6. The logistics warehouse control system according to claim 1, wherein
the parameter includes a threshold value that is a trigger of a material handling operation in the subsystem.

7. The logistics warehouse control system according to claim 1, wherein
the parameter includes identification information that specifies a control pattern of the subsystem.

8. The logistics warehouse control system according to claim 1, wherein
the parameter determination unit has a function of outputting performance of the logistics system according to the parameter.

9. The logistics warehouse control system according to claim 1, wherein
the parameter determination unit determines a combination of the parameters by searching a parameter space based on simulation.

10. A logistics warehouse control method comprising:
an order management step of managing a plurality of orders given to a logistics system;
a parameter determination step of determining, for a plurality of subsystems each in charge of a plurality of logistics operation processes in the logistics system, a parameter related to an operation of each subsystem based on the plurality of orders; and
a step of inputting the determined parameter to the subsystem, and processing the plurality of orders in a state where the parameter is applied.
